(19) United States
(12) Patent Application Publication
(10) Pub. No.: US 2024/0349318 A1
(43) Pub. Date: Oct. 17, 2024

(54) METHODS OF CONFIGURATION AND COMMUNICATION, ENTITY OF A TELECOMMUNICATIONS NETWORK AND USER EQUIPMENT

(71) Applicant: Orange, Issy-les-Moulineaux (FR)

(72) Inventors: Joe Saad, CHATILLON CEDEX (FR); Mohamad Yassin, CHATILLON CEDEX (FR); Salvatore Costanzo, CHATILLON CEDEX (FR)

(21) Appl. No.: 18/633,380

(22) Filed: Apr. 11, 2024

(30) Foreign Application Priority Data
Apr. 13, 2023 (FR) 2303684

(51) Int. Cl. H04W 72/512; H04W 72/542; H04W 72/566

(52) U.S. Cl. CPC H04W 72/512; H04W 72/542; H04W 72/566

(57) ABSTRACT

A method is described for the configuration, by an entity of a telecommunications network, of a user equipment connected to at least one service offered by the network. The method includes determining an inactivity timer, on the expiry of which the user equipment activates a bandwidth part defined by default according to an estimate of a traffic associated with the user equipment relating to the at least one service. The method also includes sending to the user equipment, in at least one configuration message, the inactivity timer and an indicator designating the bandwidth part defined by default, the bandwidth part defined by default corresponding to a bandwidth part assigned to the user equipment for transmitting traffic relating to a priority service from among the at least one service.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to French Patent Application No. 2303684, filed Apr. 13, 2023, the disclosure of which is hereby incorporated by reference in its entirety.

### BACKGROUND

### Technical Field

The disclosed technology belongs to the general field of telecommunications. More particularly, it lies within the context of a telecommunications network allowing a user equipment (UE) of this network to receive or send data over only part of the bandwidth allocated by the network to the cell to which this user equipment is attached.

### Discussion of Related Technology

Such functionality, also known as BWP, for “BandWidth Part”, has been introduced, notably, in the context of a 5G (i.e. 5^{th} Generation) network, and more particularly in the context of the 5G NR (for “New Radio”) network defined by the 3GPP standard, from Release 15 onwards. The bandwidth over which data associated with a UE are transmitted (i.e. sent or received by the UE) via the network, and incidentally the numerology used by the UE over this bandwidth, can be dynamically adapted by this functionality. The numerology, in the context of an OFDM (Orthogonal Frequency Division Multiplexing) scheme such as that adopted by the 5G NR radio access technology, is taken to mean the spacing between the subcarriers and the length of the cyclic prefix, or in an equivalent manner, the OFDM symbol duration.

The use of a single numerology, as in 4G or LTE (for “Long Term Evolution”) networks, namely a spacing of 15 kHz between the subcarriers and a cyclic prefix length of about 4.7 μs, is difficult to envisage in the context of a 5G network, notably because of the multiplicity of deployment scenarios envisaged, in terms of the cell sizes, the frequency bands allocated, the resulting propagation effects (such as delay spread), the heterogeneous services offered in 5G (and the consequent highly diverse constraints), or other factors. 5G NR radio access has therefore been designed to provide a degree of flexibility in this area and to support a plurality of numerologies for a single carrier frequency, as shown in Table 1 below.

TABLE 1

| Numerology μ | 0 | 1 | 2 | 3 | 4 |
|---|---|---|---|---|---|
| Spacing Δf | 15 | 30 | 60 | 120 | 240 |
| between the | | | | | |
| subcarriers | | | | | |
| (SCS, for | | | | | |
| “SubCarrier | | | | | |
| Spacing”) (kHz). | | | | | |
| Duration Tᵤ of a | 66.7 | 33.3 | 16.7 | 8.33 | 4.17 |
| payload symbol | | | | | |
| (μs) | | | | | |
| Approximate | 4.7 | 2.3 | 1.2 | 0.59 | 0.29 |
| length T_{CP} of the | | | | | |
| cyclic prefix (μs) | | | | | |
| Total duration | 71.35 | 35.68 | 17.84 | 8.92 | 4.46 |
| Tᵤ + T_{CP} of an | | | | | |
| OFDM symbol | | | | | |
| (μs) | | | | | |
| Duration of a | 1 | 0.5 | 0.25 | 0.125 | 0.0625 |
| slot (14 OFDM | | | | | |
| symbols) or TTI | | | | | |
| (for | | | | | |
| “Transmission | | | | | |
| Time Interval”) | | | | | |
| (ms) | | | | | |

By using these multiple numerologies, it is advantageously possible to meet the diverse and varied constraints (also denoted SLA, for “Service Level Agreement”) in terms of latency, throughput and reliability imposed by the various categories of service that can be offered by 5G networks. These different service categories comprise, notably:
eMBB (for “enhanced Mobile Broadband”) services, based on very high data rates, for offering new experiences to users (e.g. virtual reality, augmented reality, HD video broadcasting, etc.);
uRLLC (for “ultra Reliable Low Latency Communication”) services, which have strict requirements regarding the latency and reliability of communications (e.g. remote operation services, industrial robots, and remote surgery);
mMTC (“massive Machine Type Communication”) services, including, notably, the Internet of Things (IoT), which have high requirements, notably in terms of deployment density (e.g. connected cities, connected agriculture, etc.);
V2X (for “Vehicle to Everything”) services, enabling a vehicle to exchange data another vehicle, infrastructure elements, the network and/or a pedestrian. V2X services include safety services, for example those with the aim of minimizing accidents and risks to passengers or road users (e.g. driver assistance or autonomous driving), which require a very low latency (less than a few milliseconds) and a transmission reliability close to 100%, and other, non-safety services which are more concerned with improving traffic conditions, minimizing the effect of road congestion, improving the comfort of passengers in vehicles, etc., and which, while requiring high transmission rates, can tolerate a degree of latency and lower reliability; and
HMTC (“High performance Machine Type Communications”) services, which, like mMTC services, have high requirements in terms of deployment density (and therefore of communication resource availability), while also requiring low latency and high transmission rates.

Thus, for example, as shown in Table 1, a high numerology (corresponding to a subcarrier spacing of 120 kHz, for example) can reduce the duration of a transmission time or TTI, and incidentally the latency: it is therefore particularly suitable for uRLLC services. Conversely, a lower numerology may be used to obtain a higher data rate, and is particularly suitable for eMBB services.

As mentioned above, the 5G NR radio access technology enables a UE, via the BWP functionality, to use a narrower bandwidth than the total bandwidth allocated by a 5G network to the cell in which the UE is located. This narrower bandwidth corresponds to a part (denoted BWP below) of the total bandwidth allocated by the network to the cell. Because of the bandwidths envisaged for 5G (up to 400 MHz for a single carrier), the use of this functionality makes it possible, on the one hand, to adapt to UEs having reduced capacity in terms of the bandwidth that is supported and/or that they can monitor, and, on the other hand, to reduce the complexity of the processing performed by the UEs (e.g. monitoring and decoding of control channels) and thus their power consumption.

Each BWP is characterized by a numerology (subcarrier spacing and cyclic prefix length) and by a number of consecutive physical resource blocks (PRB) conforming to this numerology. It begins at a particular common resource block (CRB), the location of which is identified relative to a CRB acting as a reference point for all the numerologies, also called “reference point A”. Different BWPs may use the same numerology, while having different bandwidths.

It should be noted that, in the 5G NR context, a resource block (RB) (such as a PRB or a CRB) is an element defined in the frequency domain, consisting of 12 consecutive subcarriers. The frequency spreading of an RB therefore depends on the numerology concerned: thus, for example, 2 consecutive RBs for a numerology based on a spacing Δf between the subcarriers occupy the same frequency band as one RB for a numerology based on a spacing of 2Δf between the subcarriers. A PRB is therefore the smallest radio unit assigned to a UE in the 5G NR context.

FIG. 1 shows schematically the concept of a BWP. In this figure, two bandwidth parts, denoted BWP1 and BWP2, are considered, these bandwidth parts being defined within the bandwidth BW associated with a carrier C allocated to a cell of a 5G network. In the example of FIG. 1, the bandwidth parts BWP1 and BWP2 are respectively associated with two separate numerologies, corresponding to respective spacings of Δf and 2Δf between the subcarriers. The PRBs, and CRBs respectively, corresponding to the spacings of Δf and 2Δf between the subcarriers, are denoted PRB(Δf) and CRB(Δf) respectively, and PRB(2Δf) and CRB(2Δf) respectively. The bandwidth part BWP1 begins at block CRB(Δf)#m, relative to reference point A, and consists of M consecutive PRB(Δf) s, corresponding to a spacing of Δf between the subcarriers; the bandwidth part BWP2 begins at block CRB(2Δf)#n and consists of N consecutive PRB(2Δf)s, corresponding to a spacing of 2Δf between the subcarriers, M and N denoting two integers greater than or equal to 1.

According to the 3GPP standard, in a UE, four BWPs can be configured in the downlink (DL) and four BWPs can be configured in the uplink (UL) for the transmission of data associated with the UE. Here, the expression “transmission of data associated with the UE” covers, in a general manner, the reception of data by the UE and/or the sending of data by the UE. In the remainder of the description, the term BWP may equally well denote a UL BWP or a DL BWP, depending on whether it is the sending of an outgoing stream by the UE or the reception of an incoming stream by the UE that is under consideration.

Depending on the service(s) used by a UE, the activation of one BWP may be found to be more appropriate than another, notably because of the numerology associated with this BWP. This is because, as pointed out above, the higher numerologies are particularly suitable for services requiring low latency, such as uRLLC services, whereas the lower numerologies are more suitable for eMBB services requiring very high data rates. Consequently, it is not optimal to use the same numerology for two services having different constraints (or SLAs).

Now, one UE in a 5G network may be connected, or authorized to connect, simultaneously to different services. For example, the 3GPP standard has introduced the concept of “network slicing”, by which a 5G physical network can be divided into a plurality of logical “slices”, each logical slice being associated with a separate service, characterized by its own SLA and having dedicated radio resources. The same UE can be connected to 8 network slices simultaneously and can therefore access separate services simultaneously. It should be noted that a UE of a 5G network can be connected to a plurality of separate services even in the absence of network slicing.

According to the 3GPP standard, although a plurality of BWPs can be configured at the UE, only one BWP can be active (in other words, used for transmitting data associated with the UE) at a given instant in UL or DL. However, a UE can sometimes switch from one BWP to another; in other words, it can activate a new BWP to replace the current active BWP.

Such a switch may be decided by the network (the base station to which the UE is attached), for example in order to meet the quality of service (QOS) requirements of a new service required by the UE, the new BWP being considered to be more suitable, because of its numerology, than the current active BWP for transmitting the data stream for this service. It is triggered by the base station which sends downlink control information (DCI), in a physical downlink control channel (PDCCH), to the UE, in 0_1 format (for the UL) or 1_1 format (for the DL), comprising a BWP indicator (Bandwidth Part Indicator) designating the new BWP to be activated by the UE.

Additionally, if the UE no longer detects any activity in its current active BWP, it can switch automatically to a BWP defined by default with which it has previously been configured, on the expiry of what is called an inactivity timer. The duration of the inactivity timer is between 2 ms and 2560 ms.

However, the 3GPP standard does not specify any mechanism for efficiently managing a connection of a user equipment to multiple services to which it is desirable to assign different BWPs in order to optimize the transmission of the traffic associated with these services and satisfy their respective SLAs. In fact, given the aforesaid switching mechanisms, if it is desired to change the BWP for each data transmission relating to a service having different requirements, this change must be notified to the UE in a PDCCH control channel via DCI control information. Now, as mentioned above, the UE is configured to monitor the PDCCH control channel periodically. It is therefore necessary to wait for the next monitoring period of PDCCH control channel by the UE (several slots, i.e. several milliseconds) before the change of BWP can be triggered at the UE. Such a wait may be harmful for a priority service such as a uRLLC service which accepts a maximum latency of one millisecond. Thus the data packets relating to this uRLLC service, scheduled to comply with this maximum latency, may be unable to be transmitted on the resources allocated to them. This leads to a degradation of the uRLLC service.

There is consequently a need for the efficient implementation of a BWP functionality as defined by the 3GPP standard, in a network allowing a user equipment to connect to multiple heterogeneous services, typically having different priorities and/or requirements in terms of quality of service.

### SUMMARY

The disclosed technology meets the stated need, notably, by proposing a method for the configuration, by an entity of a telecommunications network, of a user equipment connected to at least one service offered by the network, said method comprising:
a step of determining an inactivity timer, on the expiry of which said user equipment activates a bandwidth part defined by default according to (i.e. as a function of) an estimate of a traffic associated with said user equipment relating to the at least one service; and
a step of sending to said user equipment, in at least one configuration message, said inactivity timer and an indicator designating said bandwidth part defined by default, said bandwidth part defined by default corresponding to a bandwidth part assigned to said user equipment for transmitting traffic relating to a priority service from among the at least one service.

In correlation, the disclosed technology also relates to a telecommunications network entity comprising:
a determination module, configured to determine an inactivity timer on the expiry of which a user equipment, connected to at least one service offered by said network, activates a bandwidth part defined by default according to an estimate of traffic associated with said user equipment relating to the at least one service; and
a sending module, configured for sending to said user equipment, in at least one configuration message, said inactivity timer and an indicator designating said bandwidth part defined by default, said bandwidth part defined by default corresponding to a bandwidth part assigned to said user equipment for transmitting traffic relating to a priority service from among the at least one service.

It should be noted that the disclosed technology can be applied equally well in uplink (UL) and downlink (DL). More particularly, if the estimate of the traffic associated with the user equipment relates to the uplink traffic, the BWP defined by default is a BWP defined by default for the uplink traffic, and is therefore to be applied in the UL. The same applies to the inactivity timer determined according to the disclosed technology. Conversely, if the estimate of the traffic associated with the user equipment relates to the downlink traffic, the BWP defined by default and the determined inactivity timer correspond, respectively, to a BWP defined by default for the downlink traffic and an inactivity timer before switching to this BWP defined by default for the downlink traffic, and are therefore to be applied in the DL.

The telecommunications network entity is, for example, a base station of the network (also called gNB in the context of a 5G network). This may be a hardware or a software entity, which may be distributed over one or more network functions or may be hosted by one or more hardware equipments.

In a known manner, a priority service is a service which has high requirements in terms of latency (a maximum latency below a given threshold, for example 1 ms). It is usually based on the transmission of data streams associated with a high priority (above a given threshold) or a QoS profile characterized by a high QoS indicator. Such a QoS indicator is, for example, a 5QI (5G QoS Identifier) value, a QCI (QOS Class Identifier) or other indicator. Thus, for example, a uRLLC service is a priority service, while an eMBB service is considered to be a non-priority service.

The disclosed technology therefore proposes, on the one hand, to make the BWP defined by default identical to the BWP assigned to the service that is most demanding in terms of latency (the priority service) to which the user equipment is connected, and, on the other hand, to adjust the inactivity timer at the end of which the user equipment switches to the BWP defined by default according to the traffic associated with this user equipment. The underlying idea on which the disclosed technology is based is that of prioritizing the transmission of the traffic relating to the priority service which has high constraints in terms of latency, while allowing a delay-free switch to the BWP assigned to this service.

In fact, by specifying the BWP assigned to the priority service as the default BWP, as soon as an absence of traffic is detected over a period extending beyond the inactivity timer, the user equipment switches automatically to this BWP. Thus, if traffic relating to the priority service is present for the user equipment, this traffic can be transmitted without delay on the BWP that has been advantageously chosen to meet the SLA of the service. There is no need to wait for the transmission of control information (e.g. DCI information) requesting this change before being able to use the BWP assigned to the priority service.

Furthermore, the inactivity timer is optimized to enable the user equipment to switch to this BWP more rapidly. For this purpose, the disclosed technology proposes to take into account the estimate of the future traffic associated with the user equipment. This estimate comprises, for example, for each service to which said user equipment is connected:
a priority associated with said service;
a volume of traffic relating to said service;
information about a scheduling of the data packets relating to said service and about a bandwidth part assigned to this service for the transmission of said data packets.

By means of this estimate of the predicted traffic for the user equipment, the network entity can determine the optimal inactivity timer to be applied in order to ensure that the priority service can be provided in accordance with the conditions of its SLA, notably as regards latency.

It should be noted that the disclosed technology may advantageously be implemented in such a way that the default BWP and the inactivity timer applied by the user equipment are adapted dynamically (these factors may then change over time according to the context of the user equipment), or, in a variant, it may be implemented in order to determine the default BWP and the inactivity timer with which the user equipment is to be configured when its connection to a base station of the network is established.

Because of the disclosed technology, a user equipment connected to a plurality of services including a priority service is assured that the traffic relating to this priority service is transmitted with a BWP and a numerology adapted to it constraints and conforming to the maximum latency that it supports. It should be noted that the implementation of the disclosed technology may result in an additional delay in the transmission of the traffic relating to the other non-priority services to which the user equipment may be connected. However, since these services are non-priority, they can accept such an additional delay without any effect on their performance.

The disclosed technology is very simple to implement. This is because it is based on mechanisms already implemented by the user equipment and by the network (switching to a default BWP on the expiry of an inactivity timer, configuration of the user equipment with a default BWP, etc.), which are suitable for the requirements of the disclosed technology because of their low complexity.

For example, the estimate of the traffic associated with a user equipment is a piece of information which is already held by the network for the purpose of organizing the transmission of this traffic. The same applies to the priority associated with each service.

Furthermore, the disclosed technology requires no modification of the formats of the existing message or the DCI control information for its implementation: the BWP defined by default, as well as the inactivity timer, can easily be supplied to the user equipment by using the standardized fields of a message according to the RRC protocol (referred to here as an RRC message), such as the defaultDownlinkBWP-Id or defaultUplinkBWP-Id field for the default BWP in the DL or the UL, and the bwp-InactivityTimer field for the inactivity timer. These fields are described, notably, in the 3GPP document TS 38.331 entitled “Technical Specification Group Radio Access Network; NR; Radio Resource Control (RRC) protocol specification; Release 17”, v17.4.0 (2023-03). Thus, in a particular embodiment, said at least one configuration message is an RRC message.

Evidently, other types of configuration message may be used in variants to communicate to the user equipment the BWP defined by default and the inactivity timer determined by means of the disclosed technology. It should also be noted that the BWP defined by default and the inactivity timer are not necessarily transmitted in the same messages. Furthermore, they are not necessarily updated at the same time, and therefore they are not necessarily transmitted with the same frequency.

The disclosed technology is also compatible with the constraint set by the 3GPP standard, according to which a user equipment can only have one BWP active at a given instant (although it should be noted that the disclosed technology is also applicable in the absence of this constraint). Subject to this constraint, it makes it possible to optimize the transmission of the traffic associated with a user equipment connected to multiple services, even when these services include a priority service.

There is no limit on the number or type of services to which the disclosed technology applies. The multiple services to which the user equipment is connected may comprise, for example, one or more of the following services:
an “ultra Reliable Low Latency Communication” (uRLLC) service;
an “enhanced Mobile BroadBand” (eMBB) service;
a “massive Machine Type Communication” (mMTC) service;
a “Vehicle to Everything” (V2X) service;
a “High Performance Mobile Type Communication” (HMTC) service.

The uRLLC and V2X services are considered to be priority services.

As mentioned previously, the disclosed technology is intended to ensure that the priority service is provided without latency, while meeting the constraints of the BWP functionality. A number of strategies may be used to determine an inactivity timer optimized for this purpose.

For example, in a particular embodiment in which the estimate of the traffic indicates an absence of traffic, the inactivity timer is set to a specified minimum value in the determination step.

For example, this specified minimum value is 2 ms, as defined in the 3GPP standard. Evidently, however, other values could be envisaged, smaller or greater than 2 ms.

This embodiment makes use of the fact that there is no traffic to be transmitted for the user equipment in the next period of time (the period for which the traffic is estimated). In these circumstances, a rapid switch to the default BWP associated with the priority service does not create any additional delay for the other services, because there is no traffic to be transmitted in this period. Furthermore, if any traffic for the priority service should appear, it could be processed without undue delay, because the BWP assigned to this service is already activated.

In another embodiment, the timer is set to a specified (or determined) minimum value if a prediction of the traffic over a specified (or determined) period of time also confirms the absence of traffic.

Such a prediction may, for example, be made using a machine learning (ML) or artificial intelligence (AI) algorithm, over a period of time extending beyond the period considered for the traffic estimation. This embodiment makes it possible to confirm the appropriateness of the choice of a minimum inactivity timer for other services.

The choice of the minimum value for the inactivity timer in these embodiments offers a compromise between simplicity of implementation and effectiveness of the mechanism for switching to the BWP defined by default for the priority services. However, it would be possible to envisage choosing the inactivity timer in a different way in the absence of traffic, for example by taking into account the traffic predictions beyond the period considered for the traffic estimation. On the basis of these predictions, a higher value could be chosen for the inactivity timer by taking into account the periods of activity and inactivity that may be observed in these traffic predictions for the priority service and for the other services.

In a particular embodiment, if said traffic estimation indicates an activity, in the determination step the inactivity timer is set on the basis of at least one performance indicator of said user equipment.

This performance indicator may be, notably, a power consumption of the user equipment.

Thus, for example, if the power consumed by the user equipment reaches or exceeds a given threshold, the inactivity timer is kept at its current value in the determination step.

By favoring the inactivity of the user equipment, this strategy makes it possible to preserve the power consumption of the equipment, which has already reached its maximum, and thus incidentally to preserve its resources, including, notably, its battery.

According to another example, if the power consumed by the user equipment is below a given threshold, the inactivity timer is increased from its current value in the determination step. For example, it would be possible to envisage increasing it by a few milliseconds.

The increase in the inactivity timer enables the presence of traffic to be taken into account.

Evidently, these examples are given only by way of illustration, and other strategies could be envisaged, just as other factors could be taken into account for determining the optimal inactivity timer, for example the location of the user equipment, the context in which it is situated, a performance indicator of the network (e.g. the end-to-end latency of the non-priority services), etc.

In another embodiment, in the determination step, the inactivity timer is determined by means of an ML or AI algorithm (for example, a reinforcement or deep reinforcement learning algorithm), a mathematical model, or a heuristic.

In a particular embodiment, the determination and sending steps are reiterated periodically.

This embodiment offers further flexibility: it enables the default BWP and the inactivity timer to be revised according to the variation of the traffic, and, if relevant, according the services to which the user equipment is connected.

However, it should be noted that the default BWP is not necessarily revised in each period, notably when the user equipment is still connected to the same priority service.

It may also be envisaged, in a particular embodiment, that there should be a period of repetition of these steps that can be configured by the network entity, for example according to the context in which the user equipment is situated or the services to which it is connected.

In a variant, the determination and sending steps can be triggered on the detection of a particular event, such as the connection of the user equipment to a new service, the appearance of incoming or outgoing traffic associated with the user equipment, etc.

In view of the above, the disclosed technology is applied not only to the network entity that implements the configuration method according to the disclosed technology for choosing in an optimized manner the default BWP and the inactivity timer, but also to the user equipment itself.

Thus, according to another aspect, the disclosed technology proposes a method of communication by a user equipment of a telecommunications network connected to at least one service offered by the network, said communication method comprising:
a step of receiving at least one configuration message from a network entity, said at least one configuration message comprising an indicator of a bandwidth part defined by default and an inactivity timer on the expiry of which said user equipment must activate said bandwidth part defined by default, said inactivity timer having been determined by said network entity according to an estimate of traffic associated with said user equipment relating to the at least one service, and said bandwidth part defined by default corresponding to a bandwidth part assigned to said user equipment for transmitting traffic relating to a priority service chosen from among the at least one service; and
a step of applying said bandwidth part defined by default and said inactivity timer.

In correlation, the disclosed technology also proposes a user equipment of a telecommunications network comprising:
a reception module, configured to receive at least one configuration message from a network entity, said at least one configuration message comprising an indicator of a bandwidth part defined by default and an inactivity timer on the expiry of which said user equipment must activate said bandwidth part defined by default, said inactivity timer having been determined by said network entity according to an estimate of traffic associated with said user equipment relating to the at least one service, and said bandwidth part defined by default corresponding to a bandwidth part assigned to said user equipment for transmitting traffic relating to a priority service chosen from among the at least one service; and
an application module, configured to apply said bandwidth part defined by default and said inactivity timer.

According to yet another aspect, the disclosed technology proposes a communication system comprising:
at least one entity of a telecommunications network according to the disclosed technology; and
at least one user equipment according to the disclosed technology, attached to said at least one entity.

The communication method, the user equipment, and the communication system according to the disclosed technology have the same aforementioned advantages as the configuration method and the network entity according to the disclosed technology. They are equally applicable in the uplink and in the downlink, as mentioned above for the configuration method and the network entity.

In one particular embodiment, the configuration and communication methods are implemented by a computer.

The disclosed technology also proposes a computer program on a recording medium, this program being able to be implemented in a computer or more generally in a telecommunications network entity according to the disclosed technology and comprising instructions designed to implement a configuration method as described above.

The disclosed technology also proposes a computer program on a recording medium, this program being able to be implemented in a computer or more generally in a user equipment according to the disclosed technology and comprising instructions designed to implement a communication method as described above.

Each of these programs may use any programming language, and be in the form of source code, object code, or of intermediate code between source code and object code, such as in a partially compiled form, or in any other desirable form.

The disclosed technology also targets a computer-readable information medium or recording medium including computer program instructions, such as mentioned above.

The information medium or recording medium may be any entity or device capable of storing the programs. For example, the medium may include a storage means, such as a ROM, for example a CD-ROM or a microelectronic circuit ROM, or else a magnetic recording means, for example a hard disk, or a flash memory.

Moreover, the information medium or recording medium may be a transmissible medium such as an electrical or optical signal, which may be routed via an electrical or optical cable, by radio link, by wireless optical link or by other means.

The program according to the disclosed technology may in particular be downloaded over the Internet.

As an alternative, the data or recording medium may be an integrated circuit in which a program is incorporated, the circuit being adapted to execute or to be used in the execution of the configuration and communication methods.

It is also possible, in other embodiments, to envisage the configuration and communication methods, the network entity, the user equipment communication system according to the disclosed technology having all or some of the abovementioned features in combination.

### BRIEF DESCRIPTION OF THE DRAWINGS

Other features and advantages of the disclosed technology will emerge from the description given below, with reference to the appended drawings that illustrate one exemplary embodiment thereof that is in no way limiting. In the figures:

FIG. 1, described above, shows the bandwidth parts (BWPs) defined on the basis of a nominal bandwidth allocated to a network;

FIG. 2 shows a communication system in a telecommunications network, according to the disclosed technology, in one particular embodiment;

FIG. 3 schematically shows the hardware architecture of a computer on which are based a network entity and a user equipment according to the disclosed technology, belonging to the communication system of FIG. 2;

FIG. 4 shows, in the form of a flowchart, the main steps of a configuration method according to the disclosed technology, as implemented by a network entity according to the disclosed technology belonging to the communication system of FIG. 2;

FIG. 5 shows, in the form of a flowchart, the main steps of a communication method according to the disclosed technology, as implemented by a user equipment according to the disclosed technology belonging to the communication system of FIG. 2;

FIGS. 6 and 7 show, in an example, the gain provided by the disclosed technology, with FIG. 6 showing an example in the absence of the disclosed technology;

FIG. 7 shows the example with the disclosed technology implemented; and

FIG. 8 shows an embodiment of the disclosed technology based on an Open-RAN architecture.

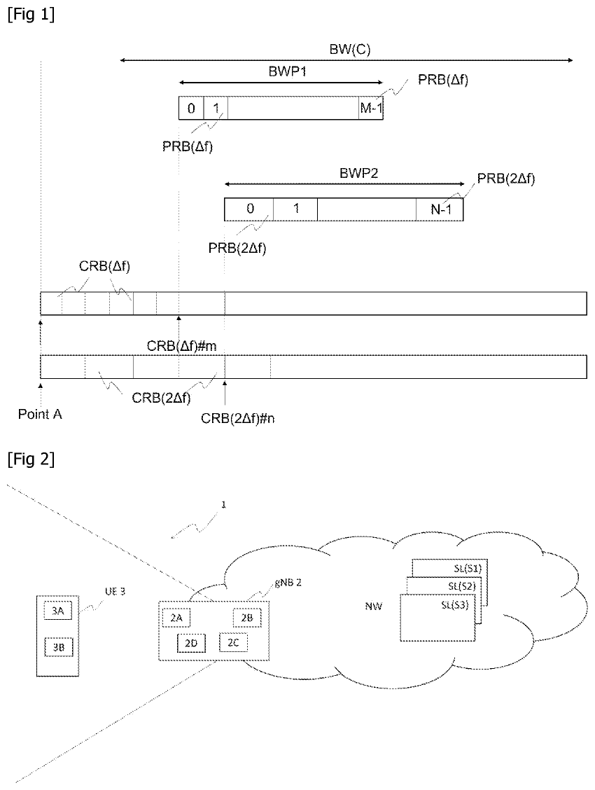

### DETAILED DESCRIPTION

FIG. 2 shows, in its environment, a communication system 1 according to the disclosed technology, in one particular embodiment.

In this embodiment, the system 1 comprises:
at least one entity 2 of a telecommunications network NW according to the disclosed technology; and
at least one user equipment or UE 3 of the telecommunications network NW, attached to said at least one entity 2, and according to the disclosed technology.

In the remainder of the description and in FIG. 2, for the sake of simplicity, a single entity 2 and a single user equipment 3, attached to this entity 2, are considered.

In the example of FIG. 2, the telecommunications network NW is a 5G NR network as defined by the 3GPP standard (except as regards the adaptations required for the implementation of the disclosed technology, described below). It implements, notably, the aforementioned BWP functionality, enabling a user equipment to use only a part of the total bandwidth allocated to the cell to which it is attached, whether this be in DL for receiving data and/or in UL for transmitting data.

In this context and in the embodiment described here, the entity 2 according to the disclosed technology is a base station (also called gNode B or gNB) of the network NW, covering at least one cell CELL of the network NW to which the UE 3 is attached and via which the UE 3 can access the services offered by the network NW. It is assumed here that the cell CELL is configured with at least one carrier frequency CF, to which the operator of the network NW has allocated a bandwidth BW (CF). Thus the BWP functionality allows the UE 3 to use for transmission (in DL or UL) only a part (BWP) of the bandwidth BW (CF) associated with a certain numerology u (denoted below by “bandwidth part BWP/u”), when it is attached to the cell CELL.

The UE 3 is configured initially, at the moment of the establishment of the connection between the UE 3 and the gNB 2, with a BWP defined by default BWP_{def(0)}/μ_{def(0)} (for the UL, or for the DL respectively), and an inactivity timer T_{inact(0)} on the expiry of which the UE 3 switches to this BWP defined by default BWP_{def(0)}/μ_{def(0)}. More precisely, during the RRC reconfiguration, the gNB 2 sends an RRC message to the UE 3 comprising a defaultUplinkBWP-Id field for the UL, or a defaultDownlinkBWP-Id field for the DL, respectively, containing an indicator designating the BWP defined by default BWP_{def(0)}/μ_{def(0)} to be used in the UL, or in the DL, respectively, together with a bwp-InactivityTimer field, completed with the value of the inactivity timer T_{inact(0)}. These fields are described in greater detail in the 3GPP document TS 38.331 cited previously.

The UE 3 is also configured so that, on each activation by the UE 3 of a current BWP (for the UL or the DL respectively) different from the BWP defined by default (for the UL or the DL respectively), a timer is triggered for a duration equal to that of the inactivity timer with which it is configured. If the timer expires and no traffic (UL or DL, respectively) associated with the UE 3 is to be transmitted, the UE 3 switches to the BWP defined by default (for the UL or the DL, respectively). It should be noted that different BWPs can be defined by default in UL and in DL, as can different inactivity timers.

As mentioned previously, in addition to this mechanism for switching to the BWP defined by default, the UE 3 is informed of the BWP and the associated numerology (BWP/u) to be activated at a given instant via control information DCI intended for the UE 3 and sent by the gNB 2 in a PDCCH control channel (broadcast to the cell CELL). The DCI control information carried in the PDCCH control channels may have different formats depending on the elements that it carries. The DCI control information in a 0_1 format (dedicated to the UL) or in a 1_1 format (dedicated to the DL) contains, in addition to the location of the resources in time and frequency allocated in the UL and/or in the DL to the UE 3, an indicator of a BWP to be activated by the latter, this indicator designating in a unique manner a BWP to be activated by the UE 3 and the associated numerology to be used. The 0_1 and 1_1 formats of the DCI control information and the elements that they contain, together with the other formats of DCI control information proposed by the 3GPP standard, are described, notably, in paragraph 7.3 of the 3GPP document TS 38.212 entitled “Technical Specification Group Radio Access Network; NR; Multiplexing and channel coding (Release 17)”, v17.5.0, March 2023.

It should be noted that the disclosed technology may be applied in other contexts or to other architectures than that described here, for example in an Open-RAN context (as described in greater detail below) or in a future generation network, or possibly in a proprietary network, provided that this implements a BWP functionality allowing a user equipment of the network to use only a part of the bandwidth allocated to the cell to which it is attached for transmitting (i.e. sending and/or receiving) data.

In a known manner, the telecommunications network NW allows a plurality of services to be offered to its subscribers, each service being associated with specific constraints, notably in terms of latency, transmission reliability, etc., defined by an SLA (service level agreement). By way of illustration, the following services are considered here for the network NW:
an eMBB service S1 (e.g. virtual reality, augmented reality, HD video broadcasting, etc.), requiring high data transmission rates;
a uRLLC service S2 (e.g. autonomous driving or remote management) requiring a low latency (less than a millisecond) and high reliability of data transmission; and
a mMTC service (e.g. IoT), with a high requirement in terms of deployment density.

In a known manner, the service S2 is considered to be a priority service, because of the low latency that it supports (below a given threshold, namely one millisecond). The other services are considered to be non-priority.

Furthermore, in the embodiment described here, the network NW implements network slicing. Each slice SL is a logical sub-network based on the physical infrastructure of the network NW, to which specific resources (e.g. hardware and software resources, etc.) are allocated. The various slices SL of the network are therefore advantageously isolated from each other and can access their own resources.

Here, each slice offers a separate service, and is identified by a unique slice identifier, such as an S-NSSAI (“single-network slice selection assistance information) identifier defined in the 3GPP standard. Thus, in the example of FIG. 2, the slice SL(S1) is configured to offer the service S1 and is identified by the identifier S-NSSAI1, the slice SL(S2) is configured to offer the service S2 and is identified by the identifier S-NSSAI2, and the slice SL(S3) is configured to offer the service S3 and is identified by the identifier S-NSSAI3. Consequently, according to this configuration, the identifier S-NSSAIn associated with a slice SL(Sn), where n denotes an integer equal to 1, 2 or 3 in the example considered, not only identifies this slice uniquely, but also identifies the service Sn that it offers.

It is assumed here by way of illustration that the UE 3 is connected simultaneously to multiple slices of the network NW, and more particularly to the slices SL(S1) and SL(S2) via which it can access the services S1 (non-priority) and S2 (priority), respectively.

Evidently, these assumptions are not limiting in themselves and this example is given solely by way of illustration. Thus, other services may be offered by the network NW in addition to, or as variants of, the aforesaid services, such as a V2x service (which may, depending on the scenario envisaged, require a latency of less than a few milliseconds and a reliability close to 100% (for what are known as “Safety-related V2x” scenarios, including autonomous driving for example), or, in a variant, a high transmission rate, a higher latency and low reliability (for what are known as “Non-safety-related V2x” scenarios, including, for example, high-speed mobile entertainment products), an HMTC service (requiring low latency, high availability and high speeds), and others. The network NW may also offer a number of separate services in each category.

The UE 3 may also be connected to a different number of slices and/or to different services. In fact, as mentioned above, according to the 3GPP standard, a UE can be connected to one or more slices (up to 8 simultaneously).

Finally, the network NW may be envisaged as offering a plurality of services having different constraints without using network slicing. In this case, each service offered by the network NW is identified in a unique way, by means of a service identifier for example.

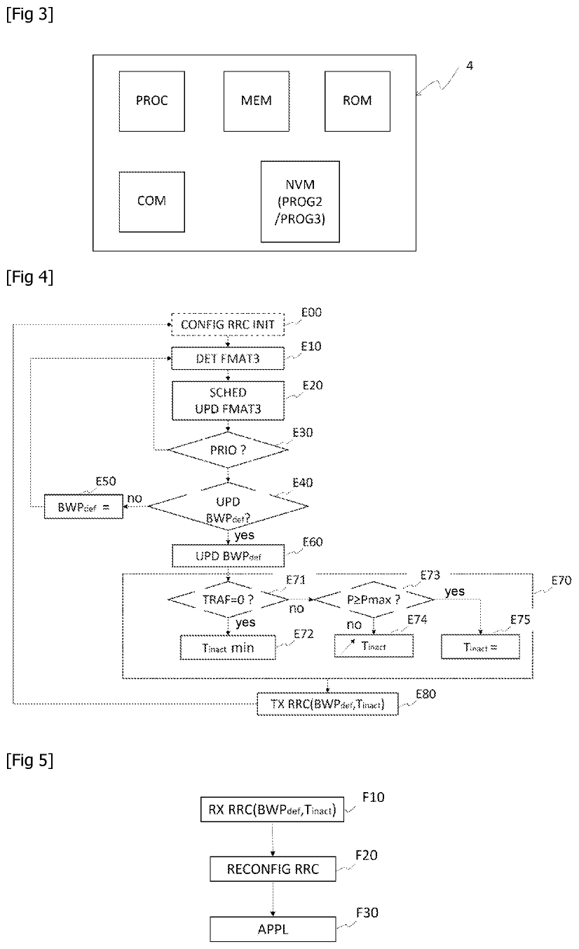

In the embodiment described here, the gNB 2 and the UE 3 have the hardware architecture of a computer 4, as illustrated in FIG. 3. This hardware architecture comprises, notably, a processor PROC, a random access memory MEM, a read-only memory ROM, a non-volatile memory NVM, and communication means COM enabling the gNB 2 and the UE 3, notably, to communicate with each other. The non-volatile memory NVM constitutes a recording medium according to the disclosed technology, readable by the processor PROC, and on which a program according to the disclosed technology is recorded.

This program, denoted PROG2 when the hardware architecture of the computer 4 is that of the gNB 2, is recorded in the non-volatile memory NVM and comprises instructions defining the main steps of a configuration method according to the disclosed technology as implemented by the gNB 2 (a network entity in the sense of the disclosed technology). More specifically, it defines the functional modules of the gNB 2, which are based on and/or control some or all of the aforesaid elements PROC, MEM, ROM, NVM, and COM of the computer 4.

In the embodiment described here, the program PROG2 defines, notably, the following functional modules of the gNB 2 (shown in FIG. 2), which are activated for each UE of the cell CELL for which the gNB 2 is requested to transmit data associated with this UE (more particularly, the UE 3 in the example envisaged here), in the UL or in the DL:
an estimation module 2A for estimating, over a specified period of time, traffic associated with the UE in question and relating to the service(s) (or, in an equivalent manner here, the slices) to which the UE is connected;
a scheduling module 2B or scheduler, configured so that, on the basis of the traffic estimate provided by the module 2A, it decides on the time and frequency resources to be allocated to the transmission of these streams (PRBs allocated to the UE and instants of transmission of these PRBs) and their scheduling, with allowance, notably, for the requirements of the services relating to this traffic as indicated in the SLAs. The scheduling module 2B is responsible, notably, for deciding on the BWP and the associated numerology to be activated by the UE for transmitting this traffic for each service to which this traffic relates;
a determination module 2C, configured to determine, according to the estimate of the traffic produced by the estimation module 2A and the scheduling provided by the scheduling module 2B, the BWP and the associated numerology (BWP_{def}/μ_{def}) to be used by default by the UE 3, together with an inactivity timer T_{inact} which is to be applied by the UE for the transmission of this traffic and at the expiry of which the UE 3 must activate the BWP defined by default BWP_{def}/μ_{def}. According to the disclosed technology, in the presence of a priority service (for example S2 here), the default bandwidth part BWP_{def}/μ_{def} is chosen to be equal to the BWP and to the associated numerology assigned by the scheduling module 2B to this priority service; and
a sending module 2D, configured to send to the UE, in at least one configuration message, the inactivity timer T_{inact} and an indicator designating said bandwidth part BWP_{def}/μ_{def} defined by default. In the embodiment described here, these messages conform to the RRC protocol, and are called RRC messages. It should be noted that the indicator designating the bandwidth part BWP_{def}/μ_{def} defined by default and the inactivity timer T_{inact} can be sent in the same configuration message or in separate configuration messages, notably according to the frequency at which they change, respectively.

It should be noted that the disclosed technology can be applied equally well in uplink (UL) and downlink (DL). More particularly, if the estimate of the traffic associated with the UE produced by the module 2A relates to the uplink traffic, the BWP defined by default is a BWP defined by default for the uplink traffic. The same applies to the inactivity timer determined according to the disclosed technology. Conversely, if the estimate of the traffic associated with the UE relates to the downlink traffic, the BWP defined by default and the determined inactivity timer correspond, respectively, to a BWP defined by default for the downlink traffic and an inactivity timer before switching to this BWP defined by default for the downlink traffic. For the sake of simplicity, in this case we use the same notations BWP_{def}/μ_{def}, to denote the BWP defined by default and its associated numerology, and T_{inact}, to denote the inactivity timer, regardless of whether these relate to the UL or the DL. However, BWPs associated with different numerologies u can be defined by default in UL and DL, as can different inactivity timers T_{inact}.

The functions performed by the modules 2A to 2D of the gNB 2 are described in more detail below, with reference to the steps of the configuration method according to the disclosed technology. The modules 2A and 2B are optional, the gNB 2 being able to obtain, in a variant, the estimate of the traffic associated with each UE attached to it, and/or the way in which this traffic is scheduled, from another entity of the network NW, for example for the estimation of the traffic, from a network data analysis function (NWDAF) in the context of a 5G network.

The computer program recorded in the non-volatile memory NVM, if the hardware architecture of the computer 4 is that of the UE 3, is denoted PROG3 and comprises instructions defining the main steps of a communication method according to the disclosed technology as it is implemented by the UE 3. More specifically, it defines the functional modules of the UE 3, which are based on and/or control some or all of the aforesaid elements PROC, MEM, ROM, NVM, and COM of the computer 4.

The program PROG3 defines, notably, the following functional modules of the UE 3 (shown in FIG. 2):
a reception module 3A, configured for receiving at least one configuration message (for example, at least one RRC message) from a network entity according to the disclosed technology, and more particularly, here, from the gNB 2. This or these configuration messages comprise, notably, an indicator of the BWP defined by default BWP_{def}/μ_{def} and of the inactivity timer T_{inact} determined by the gNB 2 for the UE 3 according to the estimate of its traffic; and
an application module 3B, configured to apply the BWP defined by default BWP_{def}/μ_{def} and the inactivity timer T_{inact} received by the reception module 3A.

The functions performed by modules 3A and 3B of the UE 3 are described in more detail below, with reference to the steps of the communication method according to the disclosed technology.

For the sake of simplicity, even though, as mentioned previously, the disclosed technology is equally applicable in both UL and DL, this description is limited to DL access to the services S1 and S2 by the UE 3, in other words to descending traffic received by the UE 3 via the network NW. Persons skilled in the art would have no difficulty in adapting the following description to the transmission of uplink traffic, that is to say traffic sent by the UE 3 toward a remote entity, which may be located within or outside the network NW. For this purpose, it is sufficient to transpose the description given for the incoming traffic (DL) to the outgoing traffic (UL). Similarly, persons skilled in the art would have no difficulty in adapting the description to a combined transmission of uplink and downlink traffic, regardless of the multiplexing technique considered between the UL and the DL (TDD (Time Division Duplex) or FDD (Frequency Division Duplex)), the disclosed technology being applied independently to the uplink and the downlink.

FIG. 4 describes the main steps of a configuration method according to the disclosed technology, in a particular embodiment in which it is implemented by the gNB 2.

As mentioned previously, following the RRC reconfiguration of the UE 3 during the establishment of the connection between the UE 3 and the gNB 2, the BWP defined by default in DL for the UE 3 and the inactivity timer after which the UE 3 switches to the BWP defined by default in DL are configured, respectively, with the bandwidth part BWP_{def(0)}/μ_{def(0)} and the inactivity timer T_{inact(0)} (step E00).

Because of the disclosed technology, this BWP defined by default and this inactivity timer, configured initially at the UE 3, can be modified dynamically over time by the gNB 2 in order to adapt them to the context of the UE 3 (and to its consumption of the services to which it is connected). In the remainder of the description, the terms “current BWP defined by default”, denoted BWP_{def}/μ_{def}, or “current inactivity timer”, denoted T_{inact}, designate the BWP defined by default and the associated numerology, or the inactivity timer, respectively, configured at the UE 3 and applied at the instant considered by the UE 3. Thus, after step E00 of RRC reconfiguration of the UE 3:

BWP_{def}/μ_{def}=BWP_{def(0)}/μ_{def(0)} and T_{inact}=T_{inact(0)}.

The steps of the configuration method described below show how these current parameters are updated by the gNB 2 according to the disclosed technology, in a particular embodiment.

More precisely, the gNB 2 determines, via its estimation module 2A, characteristics of the incoming traffic associated with the UE 3 relating to each service to which the UE 3 is connected, that is to say to which the user of the UE 3 has subscribed or has negotiated access (step E10). In the illustrative example envisaged here, these services are services S1 and S2 for the UE 3.

The characteristics of the incoming traffic are estimated by the estimation module 2A over a given period of time, for example the duration of one frame (10 ms). Evidently, a longer or shorter period of time can be envisaged as a variant.

More particularly, the estimation module 2A estimates, for each service (or, in an equivalent manner here, each slice) to which the UE 3 is connected, the volume (that is to say, the number of data packets) to be transmitted for the UE 3 for each QoS stream identified for this service, each QoS stream possibly consisting of multiple service data streams relating to the UE 3 having the same QoS requirements. One or more QoS streams (and, incidentally, a plurality of service data streams) may be received by the UE 3 in the DL for the same service (in other words, for the same slice in this case).

According to the 3GPP standard, each QoS stream is associated with a 5QI value. 5QI values are scalar numbers defined in a standardized or non-standardized way for different categories of stream (GBR (guaranteed bit rate), non-GBR (non-guaranteed bit rate) and Delay Critical GBR). Each 5QI value points to a unique QoS profile, comprising a set of values assigned to various QoS parameters to be applied to all the service data streams related to the QoS stream to which this 5QI value is assigned. These QoS parameters include, for example, a priority level, a maximum acceptable delay for a data packet (or PDB, for “Packet Delay Budget”) (latency or jitter), a packet error rate (PER), a guaranteed bit rate, a maximum bit rate, etc. More comprehensive details of 5QI values are available in the 3GPP document TS 23.501 entitled “Technical Specification Group Services and System Aspects; System Architecture for the 5G System (5GS); Stage 2 (Release 17)”, v 17.8.0 (2023-03).

A 5QI value is therefore used to characterize the QoS parameters to be met by a QoS stream associated with a service, and incidentally the service data streams related to this QoS stream. For example, a 5QI value of 1, associated with a priority level of 20, a PDB of 100 ms and a PER of 10⁻², may be used to characterize a GBR stream of a voice call service. For example, a 5QI value of 2, associated with a priority level of 40, a PDB of 150 ms and a PER of 10⁻³, may be used to characterize a GBR stream of a voice service.

Such a 5QI value is conventionally provided by the gNB 2 to a UE (the UE 3 here, for example) when it is attached to the gNB 2, for each service data stream that can be sent by the UE and related to a QoS stream.

Evidently, other indicators may be envisaged for characterizing the latency requirements of a service data stream associated with a UE (or of a QoS stream to which such a service data stream is related), for example a QoS class indicator (or QCI), a priority indicator reflecting the latency requirements of the data stream, etc.

In the embodiment described here, the estimation module 2A obtains, at the end of step E10, a matrix of incoming QoS streams associated with the UE 3, denoted FMAT(3). The columns of this matrix represent the services (or slices in this case) to which the UE 3 is connected, while its rows correspond to the various QoS streams relating to each service, each QoS stream being associated with a 5QI value.

The matrix of QoS streams FMAT(3) obtained by the estimation module 2A contains, for each service (or slice) to which the UE 3 is connected, and for each QoS stream relating to this service associated with a 5QI value, the volume of the service data streams (that is to say, the number of data packets carried in these streams) related to this QoS stream.

For example, the matrix of QoS streams FMAT(3) takes the form shown in Table 2 at the end of step E10:

TABLE 2

| | Slice | Slice |
|---|---|---|
| FMAT(3) | SL(S1) | SL(S2) |
| QoS stream DF1, | nb1 | 0 |
| value 5QI1 | | |
| QoS stream DF2 | nb2 | 0 |
| Value 5QI2 | | |
| QoS stream DF3 | 0 | nb3 |
| Value 5QI3 | | |

where:
5QI1 and 5QI2 denote the 5QI values associated, respectively, with the QoS streams DF1 and DF2 relating to the non-priority service S1 (that is to say, the QoS streams that can be exchanged in the context of this service). The values 5QI1 and 5QI2 supply, notably, the maximum latencies (PDB delays) supported by the QoS streams DF1 and DF2 (and incidentally by the data streams related to these QoS streams). The QoS streams DF1 and DF2 comprise, respectively, nb1 and nb2 data packets (that can be carried by one or more service data streams); and
5QI3 denotes the 5QI value associated with the QoS stream DF3 relating to the priority service S2 (that is to say, the stream that can be exchanged in the context of this service). This value 5QI3 supplies, notably, the maximum latency (PDB delay) supported by the QoS stream DF3 (and incidentally by the service data streams related to this QoS stream DF3). The QoS stream DF3 comprises nb3 data packets (that can be carried by one or more service data streams).

Evidently, other forms of matrices or other data structures may be envisaged for collecting the stream characteristics estimated by the estimation module 2A.

The characteristics contained in the matrix of streams FMAT(3) may be estimated by the module 2A according to information gathered from one or more sources.

Thus, for example, the module 2A may obtain some or all of the characteristics of the incoming QoS streams intended for the UE 3 from information supplied by the remote entity or entities that originated the incoming streams intended for the UE 3. If the disclosed technology is applied to the outgoing traffic sent by the UE 3, the module 2A can obtain the characteristics of this outgoing traffic from information supplied by the UE 3 that originated this outgoing traffic.

The estimation module 2A can also obtain some or all of the characteristics of the incoming QoS streams intended for the UE 3 from information held by the gNB 2. In fact, the gNB 2 knows, for each slice of the network NW, the identifier (S-NSSAI) of this slice, the services offered by it, and the UEs connected to the slice. It can also determine, by interrogating the network access and mobility function (AMF) of the network NW, the slices to which a particular UE is authorized to connect following its registration in the network. The gNB 2 also holds the SLAs associated with each service provided by the network NW, enabling it to identify the QoS streams relating to this service and the 5QI values associated with these QoS streams (and, incidentally, the maximum latency supported by each QoS stream).

According to another option, the estimation module 2A may use, for obtaining some or all of the characteristics of the incoming QoS streams associated with the UE 3, a prediction model of the incoming traffic associated with the UE 3, created for each service offered by the network NW to which the UE 3 is connected. In the illustrative example considered here, where the two slices SL(S1) and SL(2) are authorized for the UE 3, and only the incoming traffic associated with the UE 3 is taken into account, such a model MOD(3) comprises two components, a first component MOD(3,S1) corresponding to a DL traffic prediction model created for the UE 3 for the service S1 (or, in an equivalent manner, for the slice SL(S1)) and a second component MOD(3,S2) corresponding to a DL traffic prediction model created for the UE 3 for the service S2 (or, in an equivalent manner, for the slice SL(S2)); i.e. MOD(3)=[MOD(3,S1); MOD(3,S2)]. Such a prediction model MOD(3) may be learnt (that is to say, constructed and updated until it converges toward a stable model) in a known manner, on the basis of learning data collected in a preliminary learning phase, these learning data corresponding to the aforesaid characteristics (QOS streams, associated 5QI values and volume) determined for the incoming streams associated with the UE 3 during the learning phase, whenever the UE 3 is connected to a service offered by a slice of the network NW. Such learning may or may not be supervised.

In a variant, the estimation module 2A may use, for each service to which the UE 3 is connected or is authorized to connect, a model for predicting the incoming traffic associated with a plurality of UEs attached to the gNB 2 and connected to this service (the plurality of UEs is, for example, a group of UEs connected or authorized to connect to the same slices, or all the UEs attached to the gNB 2).

According to yet another option, some or all of the characteristics of the incoming QoS streams associated with the UE 3 contained in the matrix FMAT(3) can be obtained by the module 2A from other entities of the network NW having visibility on these QoS streams, such as an NWDAF network function as described in the 3GPP document TS 23.288, entitled “Technical Specification Group Services and System Aspects; Architecture enhancements for 5G System (5GS) to support network data analytics services (Release 17)”, v 17.8.0 (2023-03).

On the basis of the characteristics of the incoming traffic contained in the matrix FMAT(3) at the end of step E10, the scheduling module 2B of the gNB 2 decides on the scheduling of the data packets carried by these streams (step E20). Different types of schedulers may be envisaged in the context of the disclosed technology, such as a scheduler configured to schedule the data stream packets belonging to different slices, as described in the document by M. Raftopolou et al., entitled “Optimisation of Numerology and Packet Scheduling in 5G Networks: To Slice or not to Slice”, IEEE 93rd Vehicular Technology Conference, 2021, or in the document by X. Zhang et al., entitled “RB Allocation Scheme for eMBB and uRLLC coexistence in 5G and Beyond”, Wireless Communications and Mobile Computing, vol. 2021, 11 Oct. 2021. These examples are given solely by way of illustration, and do not limit on the schedulers that can be used in the context of the disclosed technology.

Thus the scheduling module 2B assigns a BWP associated with a numerology u, denoted BWP/u, to each service to which the UE 3 is connected (S1 and S2 in the example envisaged here), on the basis of a knowledge of these services and of their respective priorities or their respective latency requirements. The choice made by the scheduling module 2B of the bandwidth part BWP/u to be activated for the transmission of the QoS streams relating to a service takes into account the SLA associated with the service: the chosen BWP and numerology μ make it possible to comply with the SLA of the service. For example, a bandwidth part BWP2 (extracted from the bandwidth BW (CF) allocated to the cell CELL) associated with a high numerology μ2 (e.g. μ2=3 or 4 in Table 1), hereafter denoted BWP2/μ2, is chosen for the QoS streams relating to the priority service S2 (stream DF3), while a bandwidth part BWP1 (extracted from the bandwidth BW (CF) allocated to the cell CELL) associated with a lower numerology μ1 (e.g. μ1=0 or 1 in Table 1), hereafter denoted BWP1/μ1, is chosen for the streams DF1 and DF2 relating to the non-priority service S1.

Additionally, the scheduling module 2B assigns, for each QoS stream of the matrix of streams FMAT(3) corresponding to non-zero traffic:
a set of PRBs for the transmission of the data packets of the service data streams relating to this QoS stream in the BWP assigned to the service to which this QoS stream relates; and
instants of transmission (TTIs) of these PRBs.

The bandwidth parts and associated BWP/u numerologies, the PRBs and the instants of transmission chosen by the scheduling module 2B for the UE 3 for each of the incoming QoS streams associated with the UE 3 are entered here in the matrix of streams FMAT(3).

In the embodiment described here, the module 2C for determining of the gNB 2 then identifies whether the UE 3 is connected to a priority service (test step E30). This may be done on the basis of the estimate made in step E10 (and therefore on the basis of the content of the matrix FMAT(3)), or on the basis of the information held by the gNB 2 concerning the slices to which the UE 3 is connected, as mentioned previously.

If this is not the case (if the answer to the test step E30 is “no”), the gNB 2 does not change the configuration of the UE 3, and, in particular, the current BWP defined by default BWP_{def}/μ_{def} for the incoming traffic of the UE 3 and the current inactivity timer T_{inact} applied by the UE 3. The method is repeated from step E10 for a new period of time in which the estimation module 2A estimates the incoming traffic intended for the UE 3 (one new frame in the example considered here).

If the UE 3 is connected to a priority service (if the answer to the test step E30 is “yes”), as is the case here, the UE 3 being connected to the priority service S2, the determination module 2C determines whether the current bandwidth part BWP_{def}/μ_{def} defined by default for the UE 3 coincides with the BWP and the associated numerology assigned to the priority service S2, namely BWP2/μ2 in this case (test step E40).

If appropriate (if the answer in step E40 is “yes”), the current bandwidth part BWP_{def}/μ_{def} defined by default for the DL traffic of the UE 3 and configured at the UE 3 is kept as it stands (step E50).

Otherwise (if the answer in step E40 is “no”), the determination module 2C updates the current bandwidth part BWP_{def}/μ_{def} defined by default for the UE 3 with the bandwidth part assigned to the priority service for the UL by the scheduling module 2B (step E60). Thus, in the illustrative example envisaged here:

$${BWP}_{def} / {μ}_{def} = BWP 2 / μ2 .$$

The determination module 2C also determines the inactivity timer T_{inact} to be considered by the UE 3 in order to switch to this bandwidth part BWP_{def}/μ_{def} defined by default (step E70). For this purpose, in step E70, the determination module 2C takes into account the estimate of the incoming traffic produced by the estimation module 2A and stored in the matrix of QoS streams FMAT(3).

More specifically, the determination module 2C initially examines whether the matrix of streams FMAT(3) (estimate of the incoming traffic in the sense of the disclosed technology) indicates an absence of traffic, across all services, for the period of time over which it has been estimated (one frame in the example envisaged here) (test step E71).

If this is the case (if the answer to test step E71 is “yes”), the determination module 2C sets the inactivity timer T_{inact} to its minimum value (step E72). In the case of the 3GPP standard, this minimum value is set at 2 ms. Evidently, other minimum values can be envisaged as variants.

If, on the contrary, the matrix of streams FMAT(3) indicates the presence of traffic for at least one of the services to which the UE 3 is connected (if the answer to test step E71 is “no”), then, in order to determine the inactivity timer T_{inact}, the determination module 2C also examines here a performance indicator of the UE 3, namely the power P consumed by the UE 3 (test step E73).

More precisely, if the determination module 2C determines that the power P consumed by the UE 3 reaches or exceeds a given threshold Pmax (if the answer at test step E73 is “yes”), the determination module 2C keeps the current value of the inactivity timer T_{inact} (step E74). Pmax is the maximum value of the power that can be consumed by the UE 3; it is set by the operator of the network NW in view of the limits set by the current Regulations, and is known by the gNB 2.

Conversely, if the determination module 2C determines that the power P consumed by the UE 3 is below the threshold Pmax (if the answer at test step E73 is “no”), the determination module 2C increases the value of the inactivity timer T_{inact} relative to its current value (step E75). In the example envisaged here, it increases it by a specified number of milliseconds (for example, 1 ms).

In another embodiment, the determination module 2C may use other indicators to determine the inactivity timer T_{inact}, relative to the performance of the UE 3 or of the network (for example, an end-to-end latency of each service in the network).

In yet another embodiment, the determination module 2C may determine, in step E70, the inactivity timer to be applied by means of an ML or AI algorithm (for example, a reinforcement or deep reinforcement learning algorithm), a mathematical model, or a heuristic.

The sending module 2D of the gNB 2 then sends the parameters determined in this way (bandwidth part defined by default and associated numerology, and inactivity timer) to the UE 3 (step E80).

In the embodiment described here, this sending takes place via an RRC configuration message.

Thus, if the bandwidth part BWP_{def}/μ_{def} defined by default and the inactivity timer T_{inact} have both been modified in steps E60 and E72 or E75, the module 2D sends a single RRC configuration message, comprising a defaultDownlinkBWP-Id field containing an indicator designating the bandwidth part BWP_{def}/μ_{def} decided on in step E60, and a bwp-InactivityTimer field completed with the value of the inactivity timer T_{inact} determined in step E72 or E75. As a variant, the module 2D may send two RRC configuration messages, one containing the field defaultDownlinkBWP-Id containing an indicator designating the bandwidth part BWP_{def}/μ_{def} decided on in step E60, and the other containing a field bwp-InactivityTimer completed with the value of the inactivity timer T_{inact} determined in step E72 or E75.

If only one of these parameters has been modified in step E60 or step E70, the module 2D sends an RRC configuration message comprising the field defaultDownlinkBWP-Id or bwp-InactivityTimer, according to the modified parameter, duly completed.

If none of the parameters has been modified in steps E60 and E70, in the embodiment described here, the module 2D sends no RRC configuration message to the UE 3. In a variant embodiment, it may send one or more messages with the bandwidth part indicators and inactivity timers kept at the respective current values and already applied by the UE 3.

In the example envisage here, it is assumed that the default bandwidth part BWP_{def}/μ_{def} has been modified in step E60, as has the inactivity timer T_{inact}, by application of step E72; the module 2D therefore sends the UE 3 an RRC configuration message comprising the field defaultDownlinkBWP-Id containing an indicator designating the bandwidth part BWP2/μ2 selected in step E60, and a field bwp-InactivityTimer completed with the value of the inactivity timer T_{inact} reduced to its minimum value of 2 ms, as decided in step E72.

Steps E10 to E80 are then reiterated periodically, and more particularly for each new frame in the example envisaged here, the current values of the bandwidth defined by default and the inactivity timer corresponding to those determined in steps E60 and E70 respectively.

In another embodiment, steps E10 to E80 can be repeated on the detection of a particular event (for example, a new service authorized for the UE 3, and/or the appearance of incoming traffic for a given service, etc.).

It should be noted that, in these different embodiments, steps E10 to E80 are executed to determine dynamically the default bandwidth part and the appropriate inactivity timer for a UE 3 as described here. However, in another embodiment, these steps may be executed in a more static context, for example upstream of the RRC reconfiguration of the UE 3, to determine the default bandwidth part and the inactivity timer to be applied when it is configured by the gNB 2 during the establishment of its connection with the latter (based, for example, on a prediction of the traffic associated with the UE 3), or after this RRC reconfiguration.

FIG. 5 illustrates the main steps of a communication method according to the disclosed technology, as they are implemented by UE 3 following step E80, in one particular embodiment.

The UE 3 receives, via its reception module 3A, the RRC configuration message(s) sent, if appropriate, by the module 2D of the gNB 2 in step E80 (step F10). This RRC message, or messages, may be used to reconfigure the current values of the BWP defined by default and of the inactivity timer applied by the UE 3, with the values of the BWP defined by default and/or the inactivity timer contained in the RRC message(s) (step F20).

Following this reconfiguration, the application module 3B of the UE 3 applies these new current values to the transmission of the incoming traffic intended for the UE 3 (step F30), until it receives any new values from the gNB 2, determined for new frames. In other words, following this reconfiguration, on the expiry of the inactivity timer T_{inact}, the UE 3 switches to the BWP defined by default associated with the priority service S2.

Thus, according to the disclosed technology, the BWP defined by default and the inactivity timer are determined according to (i.e. as a function of) the incoming traffic associated with the UE 3. However, it should be noted that tests other than those described above for steps E30, E71 and E73 can be envisaged.

For example, in a variant embodiment, in step E30, the determination module 2C may examine not only whether the UE 3 is connected to a priority service, but also whether the QoS streams associated with this priority service have a high associated 5QI value, that is to say a value above a given threshold (82, for example). In a known manner, such QoS streams support very low latency values. Thus, in this variant embodiment, the determination module 2C updates the bandwidth part defined by default with the bandwidth part assigned to the priority service if the UE 3 is connected to a priority service, and if at least one QoS stream relating to this priority service is constrained by a latency below a given threshold (or, in an equivalent manner here, if said QoS stream has a 5QI value above a given threshold).

In another variant embodiment, in step E70, the determination module 2C can examine not only the incoming traffic identified in the matrix FMAT(3), but also a prediction of the incoming or outgoing traffic associated with the UE 3 for a further specified period of time, extending beyond the period of time over which the matrix FMAT(3) was estimated. For example, in this variant, in step E70, the determination module 2C may examine whether the matrix FMAT(3) indicates an absence of streams, and, if relevant, whether the prediction confirms this absence of streams. Then, only if these conditions are met, the determination module 2C reduces the inactivity timer to its minimum value.

In another variant embodiment, in the test step E73, the determination module 2C may examine another performance indicator of the UE 3, and a performance indicator of the network, such as the end-to-end latency of each service to which the UE 3 is connected.

In another variant embodiment, the determination module 2C can determine, in step E70, the value of the inactivity timer to be applied, taking into account a prediction of the incoming traffic for the UE 3 and any periods of inactivity revealed by this prediction.

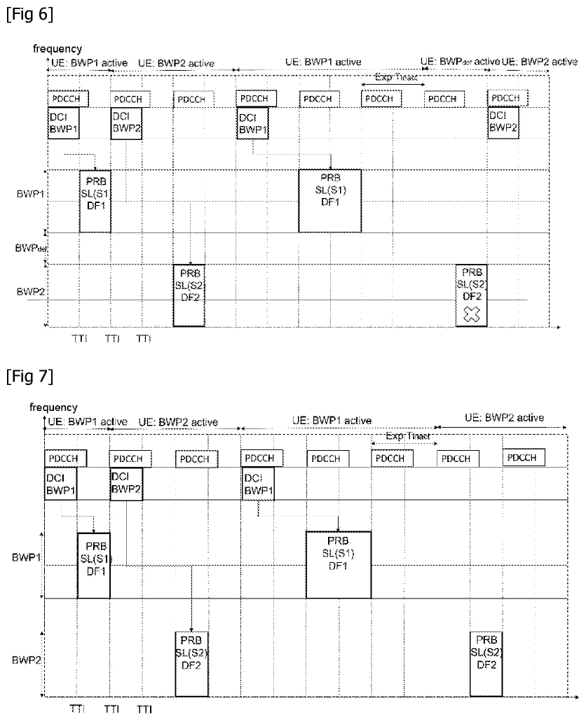

FIGS. 6 and 7 show, in a simple example, the benefits brought by the disclosed technology.

This example envisages the transmission for a UE of an incoming QoS stream DF1 relating to the eMBB service S1 offered by the SL(S1) over a bandwidth part BWP1 and an incoming QoS stream DF2 relating to the uRLLC service S2 offered by the slice SL(S2) over a bandwidth part BWP2.

FIG. 6 shows, in the absence of the implementation of the disclosed technology, the timing of the DCI information sent to a UE for activating the transmission of the streams DF1 on BWP1 and DF2 on BWP2. A default BWP (BWP_{def}), different from BWP1 and BWP2, is defined, to which the UE is configured to switch in the absence of traffic on the expiry of an inactivity timer T_{inact} with which it has been configured during the establishment of its connection to the base station.

In this context, some packets of the DF1 and DF2 streams (e.g. packets marked with a cross in FIG. 6) cannot comply with the scheduling (PRB, TTI and BWP) specified to guarantee the SLA of the services offered by the slices SL(S1) and SL(S2), because of the active BWP at the specified instant of transmission of these packets. This results in a degraded quality of service for these services, particularly for the priority service S2.

FIG. 7 shows how the situation changes when the disclosed technology is implemented. All the data packets carried by the streams DF1 and DF2 can advantageously be transmitted according to the scheduling, and the quality of the services offered by the slices SL(S1) and SL(S2) is guaranteed.

In the embodiment described above, the entity of the 5G NR network according to the disclosed technology configured to implement the configuration method according to the disclosed technology is a gNB base station. The disclosed technology is equally applicable to other network architectures, particularly to an Open-RAN architecture as defined by the O-RAN Alliance.

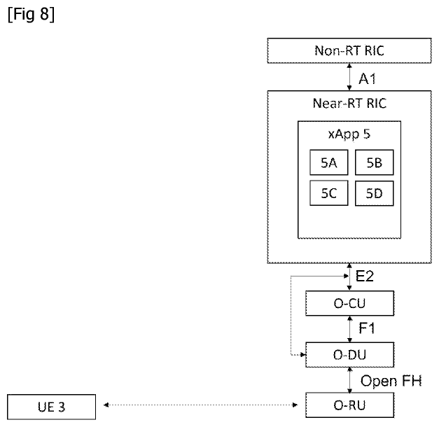

In a known manner, Open-RAN, or Open Radio Access Network, offers a development of mobile network architectures based on a fully programmable radio access network consisting of virtualized and disaggregated functions. Typically, as illustrated in FIG. 8, for a 5G NR RAN, the base station or gNB is disaggregated into multiple radio unit (O-RU, for “Open Radio Unit”), distributed unit (O-DU, for “Open Distributed Unit”) and centralized unit (O-CU, for “Open Centralized Unit”). The interfaces between these units (e.g. A1, E1, E2, etc.) are open and interoperable. Each unit is responsible for a specific function and protocol layer. For example, the O-RU unit is responsible for the lower physical layer (including the processes of FFT, beamforming, prefiltering, etc.), while the O-DU unit is responsible for scheduling, the higher physical layer and layer 2, including the MAC (Medium Access Control) protocol.

In this architecture, the RAN functions are controlled and optimized by means of an intelligent software controller or RIC (RAN Intelligent Controller). The RIC is present in two logical forms, each implementing a different function:
a Non-RT RIC (Non-Real Time RIC), responsible, notably, for managing the configurations, devices, faults, performance and life cycles of all the elements in the network, using intelligent algorithms (e.g. AI or ML) operating on a timescale of more than 1 s; and
a Near-RT RIC (Near-Real Time RIC), which hosts a large number of micro-services or xApps, based on algorithms operating on a timescale between 10 ms and 1 s. The determination and configuration of the default bandwidth part and of the inactivity timer according to the disclosed technology come into this category of algorithms, and can thus, in another embodiment, be implemented by an xApp 5 hosted by the Near-RT RIC. The xApp 5 is a (software) entity of the network according to the disclosed technology, comprising functional modules 5A to 5D similar or identical to the functional modules 2A to 2D of the gNB 2, described above. They are not described in further detail here.

Steps E00 to E80 described above are implemented by the xApp 5, in this other embodiment, in a similar or identical fashion to that described previously for the gNB 2, but involve communication interfaces belonging to the Open-RAN architecture.

Thus, in this other embodiment, the information used by the xApp 5 and obtained from the UE 3 and from the AMF function and/or from the NWDAF function, and if necessary from other entities of the network NW, to construct the matrix of the QoS streams FMAT(3), as described in step E10, are obtained by the xApp 5 via an interface E2. The bandwidth part defined by default and the inactivity timer are also supplied by the xApp 5 to the UE 3 via this interface.

If the use of a traffic prediction model for the UE 3 is envisaged for the purpose of obtaining the matrix of streams FMAT(3), the learning phase and the determination of the matrix of streams FMAT(3) by means of this prediction model can be implemented in the Non-RT RIC that manages the AI or ML algorithms. The resulting matrix of streams FMAT(3) is then transmitted to the xApp 5 hosted in the Near-RT RIC via the interface E1, which determines on the basis of this matrix the default bandwidth part and the inactivity timer to be applied.

In yet another embodiment, the network entity according to the disclosed technology is hosted in the Non-RT RIC. In this case, the same interfaces as those described above are used.

What is claimed is:

1. A method for the configuration, by an entity of a telecommunications network, of a user equipment connected to at least one service offered by the network, said method comprising:
a step of determining an inactivity timer, on the expiry of which said user equipment activates a bandwidth part defined by default according to an estimate of a traffic associated with said user equipment relating to said at least one service; and
a step of sending to said user equipment, in at least one configuration message, said inactivity timer and an indicator designating said bandwidth part defined by default, said bandwidth part defined by default corresponding to a bandwidth part assigned to said user equipment for transmitting traffic relating to a priority service from among said at least one service.

2. The configuration method as claimed in claim 1, wherein, if said estimate of the traffic indicates an absence of traffic, in the determination step the inactivity timer is set to a specified minimum value.

3. The configuration method as claimed in claim 2, wherein the timer is set to a specified minimum value if a prediction of the traffic over a specified period of time also confirms the absence of traffic.

4. The configuration method as claimed in claim 1, wherein, if said traffic estimation indicates an activity, in the determination step the inactivity timer is set according to at least one performance indicator of said user equipment.

5. The configuration method as claimed in claim 4, wherein said performance indicator is a power consumption of the user equipment.

6. The configuration method as claimed in claim 5, wherein, if the power consumed by the user equipment reaches or exceeds a given threshold, the inactivity timer is kept at its current value in the determination step.

7. The configuration method as claimed in claim 5, wherein, if the power consumed by the user equipment is below a given threshold, the inactivity timer is increased from its current value in the determination step.

8. The configuration method as claimed in claim 1, wherein the inactivity timer is determined by means of an ML (machine learning) or artificial intelligence algorithm, a mathematical model, or a heuristic.

9. The configuration method as claimed in claim 1, wherein said priority service is an “ultra Reliable Low Latency Communication” (uRLLC) service.

10. The configuration method as claimed in claim 1, wherein the determination and sending steps are reiterated periodically.

11. The configuration method as claimed in claim 1, wherein said estimate of the traffic comprises, for each service to which said user equipment is connected:
a priority associated with said service;
a volume of traffic relating to said service;
information about a scheduling of the data packets relating to said service and about a bandwidth part assigned to this service for the transmission of said data packets.

12. The configuration method as claimed in claim 1, wherein said at least one configuration message is an RRC (radio resource control) message.

13. A method of communication by a user equipment of a telecommunications network connected to at least one service offered by the network, said communication method comprising:
a step of receiving at least one configuration message from a network entity, said at least one configuration message comprising an indicator of a bandwidth part defined by default and an inactivity timer on the expiry of which said user equipment must activate said bandwidth part defined by default, said inactivity timer having been determined by said network entity according to an estimate of traffic associated with said user equipment relating to the at least one service, and said bandwidth part defined by default corresponding to a bandwidth part assigned to said user equipment for transmitting traffic relating to a priority service from among said at least one service; and
a step of applying said bandwidth part defined by default and said inactivity timer.

14. An entity of a telecommunications network, comprising:
a determination module configured to determine an inactivity timer, on the expiry of which a user equipment, connected to at least one service offered by said network, activates a bandwidth part defined by default according to an estimate of a traffic associated with said user equipment relating to said at least one service; and
a sending module, configured for sending to said user equipment, in at least one configuration message, said inactivity timer and an indicator designating said bandwidth part defined by default, said bandwidth part defined by default corresponding to a bandwidth part assigned to said user equipment for transmitting traffic relating to a priority service from among said at least one service.

15. A user equipment of a telecommunications network, comprising:
a reception module, configured to receive at least one configuration message from a network entity, said at least one configuration message comprising an indicator of a bandwidth part defined by default and an inactivity timer on the expiry of which said user equipment must activate said bandwidth part defined by default, said inactivity timer having been determined by said network entity according to an estimate of traffic associated with said user equipment relating to said at least one service, and said bandwidth part defined by default corresponding to a bandwidth part assigned to said user equipment for transmitting traffic relating to a priority service chosen from among said at least one or more service; and
an application module, configured to apply said bandwidth part defined by default and said inactivity timer.

16. A communication system comprising:
the network entity of claim 14; and
a user equipment attached to said one entity, the user equipment comprising:
a reception module, configured to receive at least one configuration message from the network entity, said at least one configuration message comprising an indicator of a bandwidth part defined by default and an inactivity timer on the expiry of which said user equipment must activate said bandwidth part defined by default, said inactivity timer having been determined by said network entity according to an estimate of traffic associated with said user equipment relating to said at least one service, and said bandwidth part defined by default corresponding to a bandwidth part assigned to said user equipment for transmitting traffic relating to a priority service chosen from among said at least one or more service; and
an application module, configured to apply said bandwidth part defined by default and said inactivity timer.
